(19) United States
(12) Patent Application Publication
(10) Pub. No.: US 2005/0036918 A1
(43) Pub. Date: Feb. 17, 2005

(54) Microchannels for efficient fluid transport

(76) Inventors: Frederick F. Lange, Santa Barbara, CA (US); Carl D Meinhart, Santa Barbara, CA (US)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/450,340

(22) PCT Filed: Dec. 18, 2001
(86) PCT No.: PCT/US01/48984

Related U.S. Application Data
(60) Provisional application No. 60/256,665, filed on Dec. 18, 2000.

(51) Int. Cl. B01L 3/00

(52) U.S. Cl. 422/100

(57) ABSTRACT

A structure having one or more micruchannels capable of forming air gaps between the inner surface of the microchannel and a fluid in the microchannel. As a result, the viscous resistance can be decreased by a factor of 5 or more. A microchannel according to this invention can have a textured inner surface which provides for air gap formation. The hydrophobicity of the microchannel can provide enhanced fluid transport by adjusting surface tension.

### CROSS REFERENCE TO RELATED APPLICATIONS

This application is based on U.S. application Ser. No. 60/256,665, filed Dec. 18, 2000.

### STATEMENT REGARDING FEDERALLY SPONSORED RESEARCH OR DEVELOPMENT

This invention was made with Government Support under Grant No. 0103514, CMS Division of Civil and Mechanical Systems Engineering, awarded by the National Science Foundation. The Government has certain rights in this invention.

### BACKGROUND OF THE INVENTION

1. Field of the Invention

The fields of the invention are fluid transport and microchannels.

2. Background Information

The ability to fabricate devices at the micro-and nano-scale has been growing significantly during the past several years. This technology will have a significant impact on society in countless ways during the next decades. One example is in the biotechnology field where delivering minute quantities of highly potent drugs to a single cell is of great interest. This requires devices capable of dispensing on the order of femto-liters (10⁻¹⁵ L) of fluid in a controlled fashion.

From a fluid mechanics perspective, the small size scale dictates a large surface to volume ratio. Subsequently, surface tension is a dominating force, and can control the functionality of the microtube for fluid delivery. Assuming that the working fluid is a hydrophilic liquid, for example, a water-based liquid, and if the micro tube is purely hydrophilic, then it will be very difficult, if not impossible, to draw fluid out of the tube. On the other hand, if the microtube is hydrophobic, then, again, it will be very difficult, if not impossible, to draw fluid into the tube. Therefore, the surface of the microtube must be designed to balance its hydrophobic and hydrophilic properties, to enhance fluid transportation through the tube.

In addition to the importance of microtube surface properties, viscous resistance to flow becomes increasingly important as the scale of the tube is decreased. Following Poiseuille's law, the volumetric flow rate of a pressure-driven viscous flow normalized by the pressure gradient scales with D⁴, where D is the diameter of the tube. The total volume contained within the tube is V=πD²L/4. Assuming the tube is self similar, that is the length is proportional to the diameter, then the total volume of the fluid contained in the tube scales as D³. Accordingly, the time to drain the tube due to viscous resistance scales with D⁻¹. Therefore, if the pressure gradient is held constant, it would take 1000 times longer to empty a 100 nm diameter tube than a 100 micron diameter tube.

For the foregoing reasons, there is a need to overcome the problems of surface tension and viscous resistance associated with fluid transport through small devices.

### SUMMARY OF THE INVENTION

The present invention provides a structure having one or more microchannels, referred to herein as microtubes, capable of dispensing femto-liter volumes of fluid in a controlled fashion. The microtubes can form air gaps between the inner surface of the microtube and a fluid in the microtube. Such air gaps can reduce viscous resistance by a factor of 5 or more. Moreover, the hydrophilic and hydrophobic surface properties of the microtubes can provide enhanced fluid transport by adjusting surface tension. In accordance with this invention, microtubes with textured inner surfaces form air gaps. The microtubes can have inner diameters from about 10 nm up to about 1000 microns.

In accordance with this invention, a structure is provided containing a microchannel, such as in a microtube, capable of forming air gaps between the its inner surface and a fluid in the microchannel, the air gaps reducing the viscous resistance of the microchannel as compared with the viscous resistance of a microchannel of similar dimensions that is incapable of forming air gaps. More particularly, the inner surface of the microchannel is textured with peaks and valleys whereby the hydrophobic and hydrophilic surface properties of the microchannel are sufficient to adjust the surface tension of a fluid so that the fluid can be transported into and out of the microchannel. For example, the peaks can be defined by particles on the surface of the microchannel, by a plurality of rings on the surface of the microchannel, or by a spiral coil attached to the inner wall of the microchannel.

### BRIEF DESCRIPTION OF THE DRAWINGS

FIG. 1 is a schematic representation of a hydrophilic fluid contained in a microtube having a textured inner surface in the form of peaks and valleys;

FIG. 2 is a schematic representation of a hydrophilic fluid contained in a microtube having a textured inner surface in the form of rings;

FIG. 3 is a schematic representation of a hydrophilic fluid contained in a microtube having a textured inner surface in the form of a spiral coil;

FIGS. 4a, b and c are scanning electron micrographs illustrating the surface coverage of the silica spheres on a polycrystalline alumina substrate;

FIG. 5 is a graph showing the experimental relation between the weight of the silica spheres versus the fraction of surface area covered on the polycrystalline alumina surface; and

FIG. 6 is a graph of contact angle as a function of area fraction of the silica spheres.

### DETAILED DESCRIPTION OF THE INVENTION

A microchannel of this invention has an inner width dimension, e.g., a diameter in a microtube, in the range of about 10 nm to about 1000 microns, preferably from about 50 nm to about 50 microns. As used herein, a textured surface is a non-smooth surface. For purposes of convenience in description, the property of the inner surface, or of components, of the microchannels of this invention to repel or attract a fluid can be referred to as its “hydrophobicity”, which means how well water wets the surface. For example, the hydrophobicity of the inner surface is hydrophobic when the inner surface of the channel are, or are treated to be, hydrophobic. The hydrophobicity of the inner surface is hydrophilic when the inner surface of the tubes are, or are treated to be, hydrophilic. Also, the invention herein will be exemplified, for convenience, with cylindrical tubes, but the invention is broadly applicable to microchannels in any structure, i.e., to conduits of circular or non-circular cross-section.

In accordance with this invention, the hydrophobicity of the inner surface of a channel such as contained in a microtube is affected by having a textured inner surface with a topography comprising, for example, peaks and valleys, rings or a spiral coil. In one embodiment, foreign material is deposited in the form of particles at spaced locations along the inner wall surface of the microtube. The result is a microtube with a textured inner surface of peaks and valleys whereby air gaps are formed between the particles that provides the microtube with the ability to draw and expel a fluid having the hydrophobicity of the particles into the microtube. The fluid can then be easily expelled since it is held only by contact with the particles.

In one embodiment, the inner wall surface of the microtube is, or is treated to be, hydrophilic and hydrophobic foreign material is deposited, e.g., in the form of particles at spaced locations along the inner wall surface. The result is a microtube with a textured inner surface of peaks and valleys that provides the microtube with the ability to draw hydrophilic fluid, such as water, into the microtube, and expel the hydrophilic fluid. In another embodiment, the inner wall surface of the microtube is, or is treated to be, hydrophobic and hydrophilic foreign material is deposited at spaced locations along the inner wall surface. The result provides the microtube with the ability to draw hydrophobic fluid, such as liquid paraffin, or other hydrophobic liquids such as oil-based liquids, materials containing lipids, and the like, into the microtube, using air gaps formed between the particles. In still other embodiments, the inner wall surface of the microtube is, or is treated to be, hydrophilic and hydrophilic foreign material is deposited at spaced locations along the inner wall surface, or is hydrophobic and hydrophobic particles are deposited. In these cases also, a fluid having the opposite hydrophobicity of the particles can then be drawn into the tube and easily expelled since it is held only by contact with the particles. While the invention can be practiced with any of the foregoing configurations, for ease of explanation, it will be illustrated by microtubes having a hydrophobic inner surface and hydrophilic peaks.

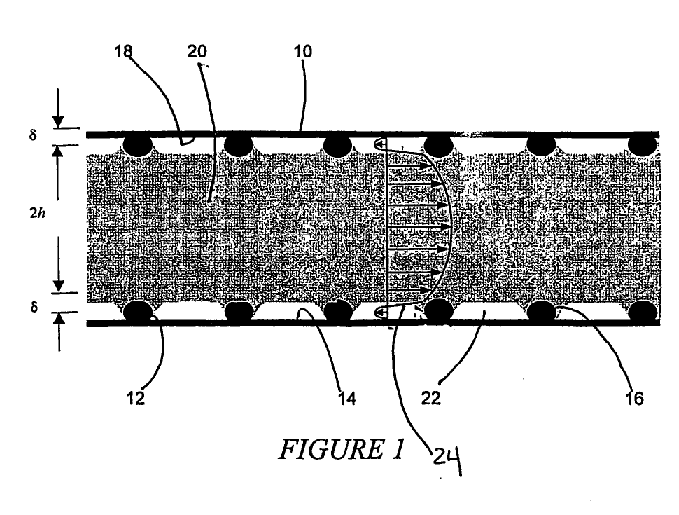

As shown in FIG. 1, a microtube according to this invention can include a microtube wall 10 made of a hydrophobic material, and hydrophobic particles 12 attached to the inner wall surface 14. The inner wall surface 14 together with the attached particles 12 make up the textured inner surface of the microtube. The topography of the textured inner surface resembles peaks 16 and valleys 18 with the peaks corresponding to the hydrophobic particles and the valleys corresponding to the hydrophobic inner wall surface. In this embodiment, the peaks are hydrophobic and the valleys are hydrophobic. The hydrophobic peak and hydrophobic surface properties of the microtube facilitate the transport of fluid through the microtube by adjusting the surface tension of the fluid. Moreover, when the microtube is filled with a hydrophilic liquid 20, for example water, thin air gaps 22 can form between the liquid 20 and the textured inner surface. To support adequate fluid flow, the inner diameter of the microtube, or width dimension of the microchannel, is preferably at least 3 times the average linear dimension of the particles.

Since the dynamic viscosity of air is 1/50th that of water, the thin air gaps serve to reduce the viscous resistance to flow in the microtube by creating a slip layer 24. By developing a simple model to predict the resistance to flow and ignoring the effect of curvature, it can be approximated that the flow through a microtube is as flow through two infinite parallel plates. Following the geometry in FIG. 1, the thickness of the liquid layer is defined as 2h and the thickness of each air gap as δ. Since the flow through nanoscale and microscale geometries can be characterized by low Reynolds number flows (Re<<1), the Stokes' equations can describe the fluid motion for both the gas and liquid phases:
∇p=μ∇² v (1)
where p is the pressure, μ is the dynamic viscosity, and v is the velocity vector. Eq. (1) can be solved simultaneously for both phases, by first assuming no net flow of air in the streamwise direction, applying the no-slip boundary condition to the microtube wall, and matching velocity and shear stress flux of the gas and liquid phases at their interface.

The effectiveness of the air gap, Φ, can be quantified by dividing the flow rate between the parallel plates with a liquid thickness 2h and an air gap of thickness δ (next to each wall), by the flow rate through the plates with just liquid of thickness 2 (h+δ). The result is
Φ=(⅓+δ/4Γh)/[3(1+δ/h)]³ (2)
where Γ is the ratio of gas and liquid dynamic viscosities. In the case of air and water, Γ=1/50. Solving (2) shows that the viscous resistance to flow is reduced by a maximum of Φ=5.86, when the ratio of δ/h=0.46.

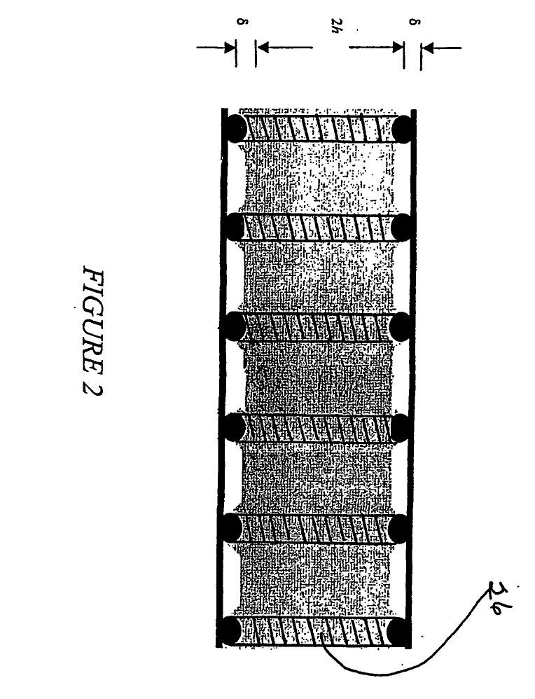

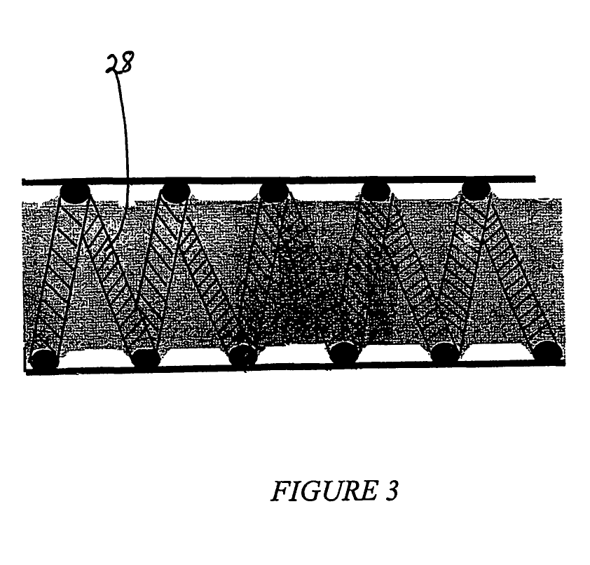

In place of peaks and valleys, the textured inner surface can have a topography comprising rings 26 attached to the inner wall surface 14 of the microtube, as shown in shadow in FIG. 2 for rings perpendicular to the longitudinal axis of the microtube . Alternatively, the topography can resemble a spiral coil 28 attached to the inner wall surface 14, as shown in shadow in FIG. 3.

In the microtube of FIG. 1, the peaks are hydrophobic and the valleys are hydrophobic. As indicated above, other embodiments can include hydrophobic peaks with hydrophilic valleys, or hydrophilic peaks and valleys. A preferred embodiment includes hydrophobic peaks and valleys. Microtubes with textured inner surfaces of rings or coils can include hydrophobic rings or coils attached to a hydrophobic inner wall surface. Other arrangements include hydrophobic rings or coils attached to a hydrophilic wall surface.

The formation of air gaps in microtubes can be analyzed using common optical techniques, for example interferometry. Such techniques are well known in the art. The interference patterns can show the existence and shape of the air gaps, similar to “Newton's Rings” which are discussed in such optical textbooks such as E. Hecht and A. Zajac, “Optics”, Addison Wesley, 1997 (3^{rd} Edition), incorporated herein by reference.

Velocity measurements of microtubes with diameters in the micron range can be determined using micron-resolution particle image velocimetry to measure details of the velocity profile. See for example the following publications which are herein incorporated by reference: (a) C. D. Meinhart, S. T. Wereley, and J. G. Santiago, “Micron-Resolution Velocimetry Techniques,” Laser Techniques Applied to Fluid Mechanics, R. J. Adrian et al. (Eds.), Springer-Verlag, Berlin, pp. 57-70, (2000); (b) C. D. Meinhart, S. T. Wereley, and J. G. Santiago, PIV measurements of a microchannel flow, Exp. Fluids, Vol. 27, No. 5, 414-419, (1999); (c) J. G. Santiago, S. T. Wereley, C. D. Meinhart, D. Beebee, and R. J. Adrian, A particle image velocimetry system for microfluids, Exp. Fluids, Vol. 25, No. 4, 316-319, (1998).

Viscous flow losses in microtubes can be determined by measuring the mass flow rate of water passing through a microtube under a given pressure difference applied across the tube. These type of measurements are commonly known in the art See for example the following publications which are herein incorporated by reference: (a) G. M. Mala and D. Li, Flow characteristics of Water in Microtubes, Int. Journal of Heat and Fluid Flow, Vol. 20. pp. 142-148, 1999; (b) W. Urbanek, J. N. Zemel, and H. H. Bau, An Investigation of the Temperature Dependence of Poiseuille Number in Microchannel Flow, Journal of Micromechanics and Microengineenng, Vol. 3, ppp. 206-209, 1993; (c) X. F. Peng, and G. P. Peterson, Convectiive Heat Transfer and Flow Friction for Water Flow in Microchannels Structure, Int. Journal of Heat and Mass Transfer, Vol. 39, No. 12, pp. 2500-2608, 1996; (d) X. F. Peng, and G. P. Peterson, The Effect of Thermofluid and Geometrical Parameters on Convection of Liquids through Rectangular Microchannels, Int. Journal of Heat and Mass Transfer, Vol. 38, No. 4, pp. 755-758, 1995; (e) X. F. Peng, G. P. Peterson, and B. X. Wang, Frictional Flow Characteristics of Water Flowing through Rectangular Microchannels, Experimental Heat Transfer, Vol. 7, pp. 249-265, 1994.

The microchannels illustrated by the microtubes of this invention have, as indicated above, inner width dimensions in the range of about 10 nm to about 1000 microns, preferably from about 50 nm to about 50 microns, and thereby include nanoscale channels and tubes. Thus carbon nanotubes can be used as microtubes of this invention. As described in U.S. Pat. No. 6,090,363, incorporated by reference herein, capped carbon nanotubes can be opened, for example, by treatment with a liquid containing an oxidizing agent, and foreign material can be deposited in carbon nanotubes, for example, by adding the foreign material to the liquid along with the oxidizing agent. In this invention, the foreign, material added along with the oxidizing agent is of sufficiently small dimension to provide a fluid flow channel through the carbon nanotubes. The carbon nanotubes can be single-walled or multi-walled.

The present invention solves the problem of viscous resistance associated with small diameter tubes. The textured inner surface of the microtube enables air gaps between the microtube wall and a liquid, which can reduce the viscous resistance by a factor of 5 or more. Moreover, the hydrophobicity characteristics of the microtube can adjust the surface tension between the active surfaces of the microtube and the liquid, providing for enhanced fluid flow. The present invention provides microtubes capable of transporting femto-liter volumes of fluid. Such microtubes filled with pharmacological agents can deliver small quantities of drugs to single cells.

### EXAMPLE

This example, using substrates with flat surfaces, shows how to form a super-hydrophobic surface having hydrophobic peaks and valleys. Basically, polycrystalline alumina substrates were dip-coated in dilute suspensions formed with dispersed, nano-silica particles. The fractional surface coverage of the alumina substrate was varied between ≈0.05 to ≈0.4 by changing concentration of particles in the silica slurry. After a heat treatment to partially sinter the particles to the surface, the surface was made hydrophobic by a reaction with a solution containing fluorosilane molecules.

The ‘as received’ silica slurry (Snowtex-OL, Nissan Chemicals, Tokyo, 20 wt %, particle size 45±5 nm, pH 3±1) was diluted with deionized water to concentrations as low as 0.025 wt %. The pH was adjusted to 6.0±0.2 with tetramethylamonium hydroxide (TMAOH) to produce a well-dispersed slurry. At pH 6, the silica particles were expected to be attractive to the alumina substrates.

Polycrystalline alumina substrates (Superstrate 996, CoorsTek, Golden, Colo., thickness 0.51 mm, unpolished) were cut into 1×1 cm pieces. The substrates were cleaned by ultrasonication in acetone, then in a cleaning solution (90% of 98% H₂SO₄, 10% of 30% H₂O₂), and finally in a 1% HF solution, after which they were rinsed in deionized water.

Different substrates were immersed into the different silica slurries for 20 min, and slowly removed and allowed to dry in a vertical position. The coatings produced with low concentration slurries were not visible to the unaided eye. Slurries containing >0.5 wt % of silica produced visible surface variations and were deemed too concentrated to produce macroscopically regular surface coverage on the alumina.

The coated substrates were heat treated to 400° C. for 20 min to partially sinter the silica spheres to the alumina surface. After heating, the specimens were placed in deionized water for 15 minutes to ensure that the surfaces were sufficiently hydrated to allow a reaction with the fluoroalkyltrichlorosilanes.

To obtain a hydrophobic surface, the silica-coated alumina samples were dried and placed in a mixture of 0.4 mL fluoroalkyltrichlorosilane (1H,1H,2H,2H-perfluorodecyltrichlorosilane, Lancaster Synthesis, Windham, N.H.), 3 mL chloroform, and 30 mL hexadecane under an argon atmosphere for 12 hours, after which they were rinsed in chloroform. Contact angle measurements were made using a contact angle goniometer (NRL CA Goniometer, Ram-Hart, Mountain Lakes, N.J.), with deionized water droplets of diameter 1.0 to 5.0 mm.

Images of the surface were obtained with a scanning electron microscope (JSM 6300FEG, JEOL). The area fraction of the silica spheres on the alumina substrates was determined by counting the number of silica spheres per unit area and multiplying this number by the cross-sectional area of an average silica sphere (diameter=45 nm). Silica spheres observed in deep crevices were omitted from the analysis.

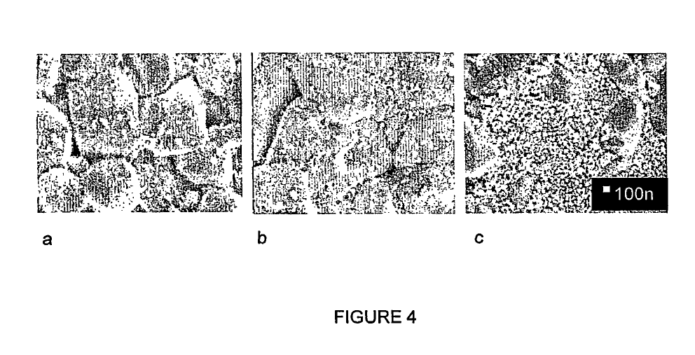

FIGS. 4a,b,c are scanning electron micrographs illustrating the typical particle distribution on the polycrystalline alumina surfaces coated with slurries containing 0.05, 0.10, and 0.40 wt % silica respectively. One can observe that the spheres have a somewhat larger size distribution than reported by the manufacturer, and many of the spheres are agglomerated. Since the particles form well-dispersed slurries, it is assumed that the agglomerates are produced after dip-coating as the meniscus moves during evaporation. The micrographs also illustrate the alumina grains and the surface topography they form, namely, deep irregular channels and nearly flat tops. At low slurry concentrations, the silica spheres appear to only cover the raised portions of the grains, while at higher concentrations, the coverage becomes more irregular, with some areas exhibiting full surface coverage.

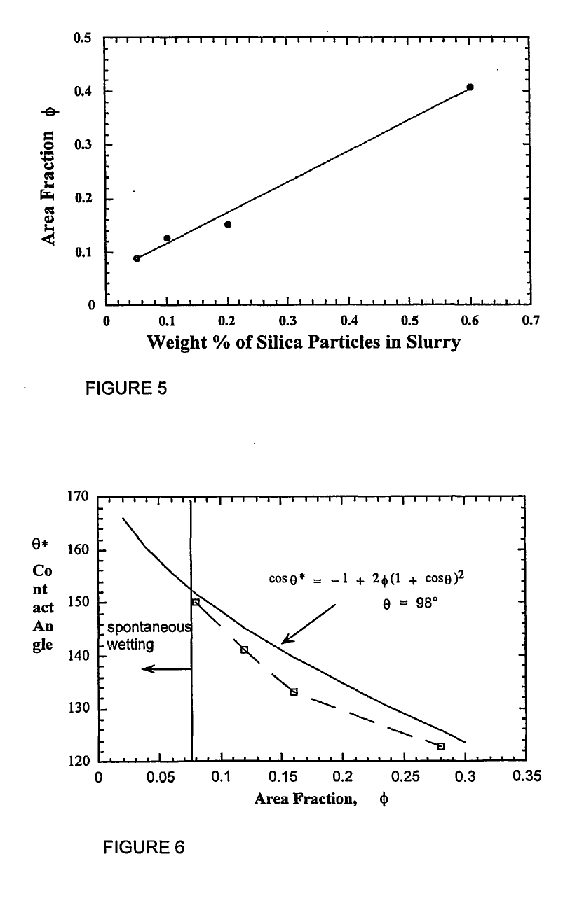

FIG. 5 plots the fraction of area covered vs. the weight percent of silica spheres in the slurry used to dip-coat the polycrystalline alumina substrate. FIG. 6 plots the average contact angle, θ*, determined for each of the different surfaces against the fraction of area covered by the silica spheres. The dashed line shows the experimental results. The solid line shows the predicted contact angle from Eq. (3) for θ=98°.
cos θ*=−1+2φ(1+cos θ)² (3)
The vertical line shows the area fraction where the super-hydrophobic effect disappears.

Super-hydrophobic surfaces were thus obtained by simply dip-coating a substrate with a slurry containing nano-silica spheres, which adhered to substrate after a low temperature heat treatment. After reacting the surface with a fluoroalkyltrichlorosilane, the hydrophobicity increased with decreasing area fraction of spheres.

Although the present invention and its advantages have been described in detail, it should be understood that various changes, substitutions and alterations can be made herein without departing from the spirit and scope of the invention. Moreover, the scope of the present application is not intended to be limited to the particular embodiments of the process, machine, manufacture, composition of matter, means, methods and/or steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the invention is intended to include within its scope such processes, machines, manufacture, compositions of matter, means, methods, or steps.

1. A structure containing a microchannel capable of forming air gaps between the its inner surface and a fluid in the microchannel, the air gaps reducing the viscous resistance of the fluid in the microchannel as compared with the viscous resistance of the fluid in a microchannel of similar dimensions that is incapable of forming air gaps.

2 The structure of claim 1 in which the hydrophobic and hydrophilic surface properties of the microchannel are sufficient to adjust the surface tension of a fluid so that the fluid can be transported into and out of the microchannel.

3. The structure of claim 1 in which the inner surface of the microchannel is textured.

4. The structure of claim 3 in which the topography of the textured surface comprises peaks and valleys.

5. The structure of claim 4 in which said peaks are defined by particles on the surface of the microchannel.

6. The structure of claim 4 in which said peaks are defined by a plurality of rings on the surface of the microchannel, the circumference of the rings lying transverse to the longitudinal axis of the microchannel.

7. The structure of claim 4 in which said peaks are defined by a spiral coil attached to the inner wall of the microchannel, the longitudinal axis of the spiral coil lying parallel to the longitudinal axis of the microchannel.

8. The structure of claim 1 in the form of a microtube.

9. The microtube of claim 8 having a textured inner surface with a topography comprising peaks and valleys, in which the peaks and valleys of the textured inner surface are hydrophobic such that said air gaps are formed between the inner surface of the microtube and a fluid in the microtube.

10. The microtube of claim 8 having a textured inner surface with a topography comprising peaks and valleys, in which the peaks and valleys of the textured inner surface are hydrophilic such that said air gaps are formed between the inner surface of the microtube and a fluid in the microtube.

11. The microtube of claim 8 having a textured inner surface with a topography comprising peaks and valleys, in which the peaks of the textured inner surface are hydrophilic and the valleys of the textured inner surface are hydrophobic such that said air gaps are formed between the inner surface of the microtube and a hydrophobic fluid in the microtube.

12. A microtube having a textured inner surface with a topography comprising peaks and valleys, in which the peaks of the textured inner surface are hydrophobic and the valleys of the textured inner surface are hydrophilic such that said air gaps are formed between the inner surface of the microtube and a hydrophilic fluid in the microtube.

13 The microtube of claim 8 having a textured inner surface with a topography comprising a series of rings attached to the inner wall of the microtube, the circumference of the rings lying transverse to the longitudinal axis of the microtube, in which the rings of the textured inner surface are hydrophilic and the inner wall is hydrophobic such that said air gaps are formed between the inner surface of the microtube and a hydrophobic fluid in the microtube.

14. The microtube of claim 8 having a textured inner surface with a topography comprising a series of rings attached to the inner wall of the microtube, the circumference of the rings lying transverse to the longitudinal axis of the microtube, in which the rings of the textured inner surface are hydrophobic and the inner wall is hydrophilic such that said air gaps are formed between the inner surface of the microtube and a hydrophilic fluid in the microtube.

15. The microtube of claim 8 having a textured inner surface with a topography comprising a spiral coil attached to the inner wall of the microtube, the longitudinal axis of the spiral coil lying parallel to the longitudinal axis of the microtube, in which the spiral coil of the textured inner surface is hydrophilic and the inner wall is hydrophobic such that said air gaps are formed between the inner surface of the microtube and a hydrophobic fluid in the microtube.

16. The microtube of claim 8 having a textured inner surface with a topography comprising a spiral coil attached to the inner wall of the microtube, the longitudinal axis of the spiral coil lying parallel to the longitudinal axis of the microtube, in which the spiral coil of the textured inner surface is hydrophobic and the inner wall is hydrophillic such that said air gaps are formed between the inner surface of the microtube and a hydrophilic fluid in the microtube.
